(19) United States
(12) Patent Application Publication
(10) Pub. No.: US 2017/0164446 A1
(43) Pub. Date: Jun. 8, 2017

(54) METHOD AND ELECTRONIC DEVICE FOR ADJUSTING DISPLAY BRIGHTNESS OF SCREEN

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventor: Yaming Tan, Beijing (CN)

(21) Appl. No.: 15/242,496

(22) Filed: Aug. 20, 2016

Related U.S. Application Data
(63) Continuation of application No. PCT/CN2016/088783, filed on Jul. 6, 2016.

(30) Foreign Application Priority Data
Dec. 3, 2015 (CN) 2015108821896

(51) Int. Cl. H05B 37/02

(52) U.S. Cl. CPC H05B 37/0227; G09G 2360/145; G09G 5/10

(57) ABSTRACT

Disclosed are a method and a device for adjusting the display brightness of a screen, and an electronic apparatus, wherein the method for adjusting the display brightness of the screen comprising: detecting a light intensity condition of the screen within a visible range; and adjusting the display brightness of the screen according to the detected light intensity condition of the screen within the visible range.

### CROSS REFERENCE TO RELATED APPLICATIONS

This application is a continuation of International Application No. PCT CN2016/088783, filed on Jul. 6, 2016 which is based upon and claims priority to Chinese Patent Application NO. 201510882189.6, titled “METHOD AND DEVICE FOR ADJUSTING DISPLAY BRIGHTNESS OF SCREEN, AND ELECTRONIC APPARATUS”, filed with the State Intellectual Property Office of PRC on Thursday, Dec. 3, 2015, the entire contents of which are incorporated herein by reference.

### TECHNICAL FIELD

The present disclosure are related to the field of electronic apparatus, and in particularly, to a method and an electronic device for adjusting the display brightness of a screen.

### BACKGROUND

With the continuous development of technology, the display effect of screens of electronic apparatus such as televisions, mobile phones and laptops are getting better and better, and also the display brightness of the screen becomes higher. However, in different environments in actual use, a light brightness condition surrounding these electronic apparatus is different. For example, when being in the evening or at night, the light in a room is darker and the light brightness surrounding a television is lower. At this time, if the screen of the television has been displaying with the higher display brightness, it will bring a bad feeling of dazzling to users, and watching the screen with the higher display brightness in the darker environment for a long time may also cause damage to the user's eyes. In the prior art, in order to solve this problem, it is generally needs to manually adjust the display brightness of the screen of the television so as to make the screen displaying with lower brightness. In the process of implementing the present invention, the inventors have found that when the user wants to watch the television again at noon of the next day or in the afternoon, it also needs to manually increase the display brightness of the screen to get a better sense of the experience, and thus the operation is very cumbersome.

### SUMMARY

In view of aforesaid problems, the disclosure is put forward to provide a method and a device for adjusting the display brightness of a screen and an electronic apparatus to overcome aforesaid problems or at least partly solve aforesaid problems.

According to one aspect of an embodiment of the present invention, there is provided a method for adjusting the display brightness of a screen, which includes:

detecting a light brightness condition of the screen within a visible range; and

adjusting the display brightness of the screen according to the detected light brightness condition of the screen within the visible range.

According to an another aspect of the embodiment of the present invention, there is provided a device for adjusting the display brightness of a screen, which includes:

at least one processor, and

a memory communicably connected with the at least one processor for storing instructions executable by the at least one processor, wherein execution of the instructions by the at least one processor causes the at least one processor to:detect a light brightness condition of the screen within a visible range; and

adjust display brightness of the screen according to the detected light brightness condition of the screen within the visible range.

According to a further aspect of the embodiment of the present invention, there is provided A non-transitory computer-readable storage medium storing executable instructions that, when executed by an electronic device with a display, cause the electronic device to:

detect a light brightness condition of the screen within a visible range; and adjust display brightness of the screen according to the detected light brightness condition of the screen within the visible range.

Above description is only a summary of the technical scheme of the disclosure. In order to know the technical means of the disclosure more clearly so that it can be put into effect according to the content of the description, and to make aforesaid and other purpose, features and advantages of the disclosure clearer, embodiments of the disclosure are listed below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 illustrates a schematic flow diagram of a method for adjusting the display brightness of a screen according to some embodiments of the present invention;

FIG. 2 illustrates a schematic functional structure diagram of a device for adjusting the display brightness of a screen according to some embodiments of the present invention;

FIG. 3 illustrates a schematic diagram of an electronic device according to some embodiments of the present invention;

FIG. 4 schematically shows hardware structure of an electronic device for adjusting the display brightness of a screen according to some embodiments of the present invention.

### DETAILED DESCRIPTION

Exemplary embodiments of the disclosure are described in further detail with reference to the drawings below. Although exemplary embodiments of the present disclosure are shown in the drawings, it should be understood that the present disclosure can be implemented in various forms and should not be limited by the embodiments set forth herein. Rather, these embodiments are provided for a more thorough understanding of the present disclosure, and to convey the scope of the present disclosure to those skilled in the art completely.

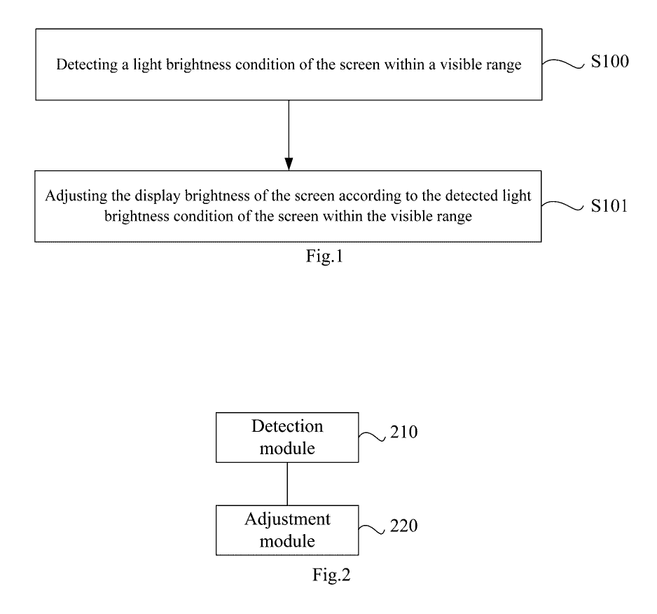

FIG. 1 illustrates a schematic flow diagram of a method for adjusting the display brightness of a screen according to an embodiment of the present invention. As shown in FIG. 1, the method includes steps as follows.

Step S100: a light brightness condition of the screen within a visible range is detected.

Specifically the light brightness condition of the screen within the visible range is related to the environment in which the user is using the screen. For example, the screen may be a screen of a fixed apparatus such as television, desktop computer, and also may be a screen of a mobile apparatus such as mobile phone, PAD or laptop computer. However, the light brightness condition of the screen within the visible range may be mainly related to the intensity of light emitted by the sun and light intensity of an illumination apparatus around the screen. It is assumed that a visible range of a screen may be a range of a few meters in front of the screen when the screen is a screen of a television.

Specifically, in the step S100, it is possible to detect the light brightness condition of the screen within the visible range at a preset time interval to obtain a light brightness value of the screen within the visible range. Specifically, the preset time interval may be a time interval such as 30 minutes, 1 hour, or 2 hours. Those skilled in the art may make specific settings for the preset time interval according to the actual needs. In order to meet different needs of individual users, the users may also customize settings of the preset time interval.

For example, when the preset time interval is 2 hours, in the step S100, the light brightness condition of the screen within the visible range is detected every 2 hours to obtain a light brightness value of the screen within the visible range.

Step S101: the display brightness of the screen is adjusted according to the detected light brightness condition of the screen within the visible range.

After the light brightness condition of the screen within the visible range is detected in the step S100, it is possible to adjust the display brightness of the screen according to the detected light brightness condition of the screen within the visible range in the step S101.

Specifically, the light brightness condition of the screen within the visible range may be detected in the step S100, and then in the step S101, the display brightness of the screen may be adjusted according to the detected light brightness value of the screen within the visible range in the step S100 and a preset light brightness threshold. Those skilled in the art may make specific settings for the preset light brightness threshold according to the actual needs. For example, the preset light brightness threshold may include a first light brightness threshold value, a second light brightness threshold and a third light brightness threshold.

When the preset light brightness threshold includes a first light brightness threshold, a second light brightness threshold and a third light brightness threshold, and the first light brightness threshold is less than the second light brightness threshold and the second light brightness threshold is less than the third light brightness threshold, the step S101 may include: adjusting the display brightness of the screen to make the screen displaying at a first brightness, when the detected light brightness value of the screen within the visible range is less than the first light brightness threshold; adjusting the display brightness of the screen to make the screen displaying at a second brightness, when the detected light brightness value of the screen within the visible range is more than or equal to the first light brightness threshold and less than the second light brightness threshold; adjusting the display brightness of the screen to make the screen displaying at a third brightness, when the detected light brightness value of the screen within the visible range is more than or equal to the second light brightness threshold and less than the third light brightness threshold; and adjusting the display brightness of the screen to make the screen displaying at a fourth brightness, when the detected light brightness value of the screen within the visible range is more than or equal to the third light brightness threshold. Specifically, the first brightness is less than the second brightness, the second brightness is less than the third brightness, and the third brightness is less than the fourth brightness.

In addition, by applying the technology solutions according to the present invention, the steps of detecting the light brightness condition of the screen within the visible range and adjusting the display brightness of the screen according to the detected light brightness condition of the screen within the visible range may be rapidly completed, thus achieving a technical effect of adjusting rapidly and automatically the display brightness of the screen. For example, by applying the technology solutions according to the present invention, the steps of detecting the light brightness condition of the screen within the visible range and adjusting the display brightness of the screen may be completed within 1-2 seconds and even less.

For example, the technical solutions according to the embodiments of the present invention may be applied to televisions. Generally, indoor lighting is adequate at noon and in the afternoon, that is, the light brightness value of the screen of the television within the visible range is higher. In this case, by applying the technical solutions according to the present invention, the display brightness of the screen may be adjusted rapidly and automatically to make the screen displaying with the higher display brightness; while indoor lighting is inadequate in the late afternoon and in the evening, that is, the light brightness value of the screen of the television within the visible range is lower. In this case, by applying the technical solutions according to the present invention, the display brightness of the screen may be adjusted rapidly and automatically to make the screen displaying with the lower display brightness.

For example, the technical solutions according to the embodiments of the present invention may be applied to mobile phones. There are many people like to browse news, stories, videos or play games for a while by means of a mobile phone after the lights are turned off and before going to sleep. At this time, if the screen of the mobile phone has been displaying with the higher display brightness, it will bring a bad feeling of dazzling to the user, and watching the screen with the higher display brightness in a darker environment for a long time may also cause damage to the user's eyes. In this case, by applying the technical solutions according to the embodiment of the present invention, the display brightness of the screen may be adjusted conveniently, rapidly and automatically, reducing the damage for the user's eye.

With the method for adjusting the light brightness of the screen according to the present embodiment, a light brightness condition of the screen within a visible range is detected, and the display brightness of the screen is adjusted according to the detected light brightness condition of the screen within the visible range. With the technical solutions according to the present invention, the display brightness of the screen can be adjusted conveniently, intelligently automatically and rapidly, the method for adjusting the display brightness of the screen is optimized, and there is provided a protection for the user's eye, improving the sense of the experience of the user.

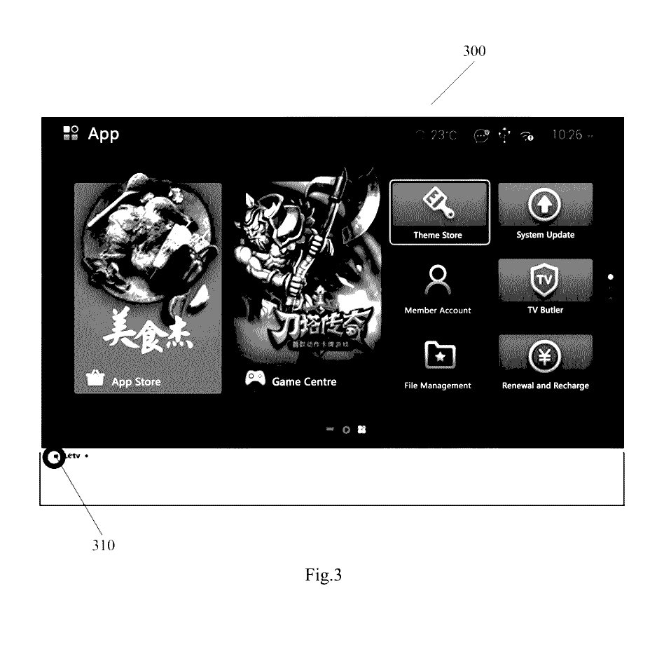

FIG. 2 illustrates a schematic functional structure diagram of a device for adjusting the display brightness of a screen according to an embodiment of the present invention. As shown in FIG. 2, the device includes a detection module 210 and an adjustment module 220.

The detection module 210 is adapted to detect a light brightness condition of the screen within a visible range.

Specifically the light brightness condition of the screen within the visible range is related to the environment in which the user is using the screen. For example, the screen may be a screen of a fixed apparatus such as television, desktop computer, and also may be a screen of a mobile apparatus such as mobile phone, PAD or laptop computer. However, the light brightness condition of the screen within the visible range may be mainly related to the intensity of light emitted by the sun and light intensity of an illumination apparatus around the screen.

The detection module 210 is further adapted to detect the light brightness condition of the screen within the visible range at a preset time interval to obtain a light brightness value of the screen within the visible range.

Specifically, the preset time interval may be a time interval such as 30 minutes, 1 hour, or 2 hours. Those skilled in the art may make specific settings for the preset time interval according to the actual needs. In order to meet different needs of individual users, the user may also customize settings of the preset time interval. It is assumed that the preset time interval is 30 minutes, and the light brightness condition of the screen within the visible range is detected every 30 minutes to obtain a light brightness value of the screen within the visible range.

The adjustment module 220 is adapted to adjust display brightness of the screen according to the detected light brightness condition of the screen within the visible range.

After the light brightness condition of the screen within the visible range is detected by the detection module 210, the adjustment module 220 is triggered to adjust the display brightness of the screen according to the detected light brightness condition of the screen within the visible range.

Specifically, the light brightness condition of the screen within the visible range may be detected by the detection module 210, and then, the display brightness of the screen may be adjusted by the adjustment module 220 according to the detected light brightness value of the screen within the visible range and a preset light brightness threshold. Those skilled in the art may make specific settings for the preset light brightness threshold according to the actual needs.

For example, when the preset light brightness threshold includes a first light brightness threshold, a second light brightness threshold and a third light brightness threshold, and the first light brightness threshold is less than the second light brightness threshold and the second light brightness threshold is less than the third light brightness threshold, the adjustment module 220 is further adapted to adjust the display brightness of the screen to make the screen displaying at a first brightness, when the detected light brightness value of the screen within the visible range is less than the first light brightness threshold; adjusting the display brightness of the screen to make the screen displaying at a second brightness, when the detected light brightness value of the screen within the visible range is more than or equal to the first light brightness threshold and less than the second light brightness threshold; adjusting the display brightness of the screen to make the screen displaying at a third brightness, when the detected light brightness value of the screen within the visible range is more than or equal to the second light brightness threshold and less than the third light brightness threshold; and adjusting the display brightness of the screen to make the screen displaying at a fourth brightness, when the detected light brightness value of the screen within the visible range is more than or equal to the third light brightness threshold. Specifically, the first brightness is less than the second brightness, the second brightness is less than the third brightness, and the third brightness is less than the fourth brightness.

With the device for adjusting the light brightness of the screen according to the present embodiment, a light brightness condition of the screen within a visible range is detected by the detection module, and the display brightness of the screen is adjusted by the adjustment module according to the detected light brightness condition of the screen within the visible range. With the technical solutions according to the present invention, the display brightness of the screen can be adjusted conveniently, intelligently automatically and rapidly, the method for adjusting the display brightness of the screen is optimized, and there is provided a protection for the user's eye, improving the sense of the experience of the user.

Embodiments of the present invention also provide an electronic device, which includes the above-described device for adjusting the brightness of a screen. Specifically, the electronic apparatus may be a television, a desktop computer, a mobile phone, a PAD or a laptop computer and other electronic device which have a screen.

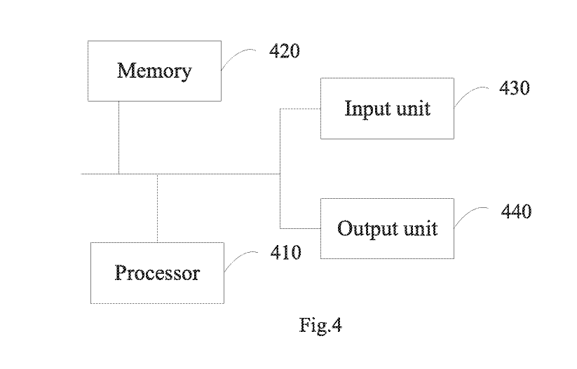

For example, when the electronic device is a television, in particular, a light-sensitive sensor may be used as a detection module in a device with the brightness of the screen to be adjusted, and the detection module and the adjustment module may be integrated anywhere in the television. However, in order to facilitate the layout of hardware and structure, preferably, the detection module 310 may be provided on the bottom of the television 300 (the position shown at a circle in FIG. 3), for example the detection module 310 is integrated on the same hardware with an infrared circuits and so on, and the adjustment module (not shown in drawings) is provided inside the television 300, as shown in FIG. 3.

Further, an embodiment of the present invention further provides a non-transitory computer-readable storage medium storing executable instructions, which can be executed by an electronic device to perform any methods for adjusting the display brightness of a screen mentioned by embodiments of the present invention.

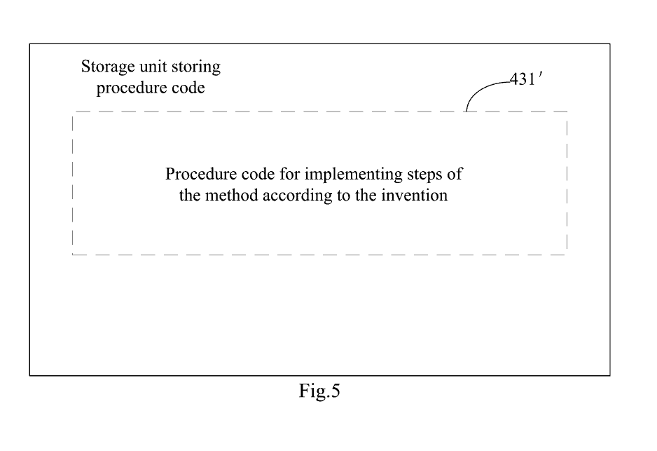

FIG. 4 is schematically shows hardware structure of an electronic device for adjusting the display brightness of a screen according to an embodiment of the present invention.

As shown in FIG. 4, the device includes: one or more processors 410 and memory 420. One processor 410 is shown in FIG. 4 for an example.

The device which is configured to perform the methods for adjusting the display brightness of a screen can also include: input unit 430 and output unit 440.

Processor 410, memory 420, input unit 430 and output unit 440 can be connected by BUS or other methods, and BUS connecting is showed in FIG. 4 for an example.

Memory 420 can be used for storing non-transitory software program, non-transitory computer executable program and modules as a non-transitory computer-readable storage medium, such as corresponding program instructions/modules for the methods for adjusting the display brightness of a screen mentioned by embodiments of the present invention (such as shown in FIG. 2, detecting module 210 and adjusting module 220). Processor 410 performs kinds of functions and data processing of the electronic device by executing non-transitory software program, instructions and modules which are stored in memory 420, thereby realizes the methods for adjusting the display brightness of a screen mentioned by embodiments of the present invention.

Memory 420 can include program storage area and data storage area, thereby the operating system and applications required by at least one function can be stored in program storage area and data created by using the device for adjusting the display brightness of a screen can be stored in data storage area. Furthermore, memory 420 can include high speed Random-access memory (RAM) or non-volatile memory such as magnetic disk storage device, flash memory device or other non-volatile solid state storage devices. In some embodiments, memory 420 can include long-distance setup memories relative to processor 410, which can communicate with the device for adjusting the display brightness of a screen by networks. The examples of said networks are including but not limited to Internet, Intranet, LAN, mobile Internet and their combinations.

Input unit 430 can be used to receive inputted number, character information and key signals causing user configures and function controls of the device for adjusting the display brightness of a screen. Output unit 440 can include a display screen or a display device.

The said module or modules are stored in memory 420 and perform the methods for adjusting the display brightness of a screen when executed by one or more processors 410.

The said device can reach the corresponding advantages by including the function modules or performing the methods provided by embodiments of the present invention. Those methods can be referenced for technical details which may not be completely described in this embodiment.

Electronic devices in embodiments of the present invention can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-11. (canceled)

12. A method for adjusting the display brightness of a screen, applying to terminals, the method comprising:
detecting a light brightness condition of the screen within a visible range; and
adjusting the display brightness of the screen according to the detected light brightness condition of the screen within the visible range.

13. The method for adjusting the display brightness of a screen according to claim 12, wherein the detecting a light brightness condition of the screen within a visible range further comprises:
detecting the light brightness condition of the screen within the visible range at a preset time interval to obtain a light brightness value of the screen within the visible range.

14. The method for adjusting the display brightness of a screen according to claim 13, wherein the adjusting the display brightness of the screen according to the detected light brightness condition of the screen within the visible range further comprises:
adjusting the display brightness of the screen according to the detected light brightness value of the screen within the visible range and a preset light brightness threshold.

15. The method for adjusting the display brightness of a screen according to claim 14, wherein the preset light brightness threshold comprises a first light brightness threshold, a second light brightness threshold and a third light brightness threshold; and
wherein the first light brightness threshold is less than the second light brightness threshold, and the second light brightness threshold is less than the third light brightness threshold;
wherein the adjusting the display brightness of the screen according to the detected light brightness value of the screen within the visible range and a preset light brightness threshold, comprises:
adjusting the display brightness of the screen to make the screen displaying at a first brightness, when the detected light brightness value of the screen within the visible range is less than the first light brightness threshold;
adjusting the display brightness of the screen to make the screen displaying at a second brightness, when the detected light brightness value of the screen within the visible range is more than or equal to the first light brightness threshold and less than the second light brightness threshold;
adjusting the display brightness of the screen to make the screen displaying at a third brightness, when the detected light brightness value of the screen within the visible range is more than or equal to the second light brightness threshold and less than the third light brightness threshold; and
adjusting the display brightness of the screen to make the screen displaying at a fourth brightness, when the detected light brightness value of the screen within the visible range is more than or equal to the third light brightness threshold.

16. An electronic device, comprising:
at least one processor, and
a memory communicably connected with the at least one processor for storing instructions executable by the at least one processor, wherein execution of the instructions by the at least one processor causes the at least one processor to:detect a light brightness condition of the screen within a visible range; and
adjust the display brightness of the screen according to the detected light brightness condition of the screen within the visible range.

17. An electronic device according to claim 16, wherein, the detecting a light brightness condition of the screen within a visible range further comprises:
detecting the light brightness condition of the screen within the visible range at a preset time interval to obtain a light brightness value of the screen within the visible range.

18. An electronic device according to claim 17, wherein, the adjusting the display brightness of the screen according to the detected light brightness condition of the screen within the visible range further comprises:
adjusting the display brightness of the screen according to the detected light brightness value of the screen within the visible range and a preset light brightness threshold.

19. An electronic device according to claim 18, wherein, the preset light brightness threshold comprises a first light brightness threshold, a second light brightness threshold and a third light brightness threshold; and wherein the first light brightness threshold is less than the second light brightness threshold, and the second light brightness threshold is less than the third light brightness threshold;
wherein the adjusting the display brightness of the screen according to the detected light brightness value of the screen within the visible range and a preset light brightness threshold, comprises:
adjusting the display brightness of the screen to make the screen displaying at a first brightness, when the detected light brightness value of the screen within the visible range is less than the first light brightness threshold;
adjusting the display brightness of the screen to make the screen displaying at a second brightness, when the detected light brightness value of the screen within the visible range is more than or equal to the first light brightness threshold and less than the second light brightness threshold;
adjusting the display brightness of the screen to make the screen displaying at a third brightness, when the detected light brightness value of the screen within the visible range is more than or equal to the second light brightness threshold and less than the third light brightness threshold; and
adjusting the display brightness of the screen to make the screen displaying at a fourth brightness, when the detected light brightness value of the screen within the visible range is more than or equal to the third light brightness threshold.

20. A non-transitory computer-readable storage medium storing executable instructions that, when executed by an electronic device with a display, cause the electronic device to:
detect a light brightness condition of the screen within a visible range; and
adjust the display brightness of the screen according to the detected light brightness condition of the screen within the visible range.

21. A non-transitory computer-readable storage medium according to claim 20, wherein the step to detect a light brightness condition of the screen within a visible range further comprises:
detecting the light brightness condition of the screen within the visible range at a preset time interval to obtain a light brightness value of the screen within the visible range.

22. A non-transitory computer-readable storage medium according to claim 21, wherein the step to adjust the display brightness of the screen according to the detected light brightness condition of the screen within the visible range further comprises:
adjusting the display brightness of the screen according to the detected light brightness value of the screen within the visible range and a preset light brightness threshold.

23. A non-transitory computer storage medium according to claim 22, wherein, the preset light brightness threshold comprises a first light brightness threshold, a second light brightness threshold and a third light brightness threshold; and wherein the first light brightness threshold is less than the second light brightness threshold, and the second light brightness threshold is less than the third light brightness threshold;
wherein the step to adjust the display brightness of the screen according to the detected light brightness value of the screen within the visible range and a preset light brightness threshold, comprises:
adjusting the display brightness of the screen to make the screen displaying at a first brightness, when the detected light brightness value of the screen within the visible range is less than the first light brightness threshold;
adjusting the display brightness of the screen to make the screen displaying at a second brightness, when the detected light brightness value of the screen within the visible range is more than or equal to the first light brightness threshold and less than the second light brightness threshold;
adjusting the display brightness of the screen to make the screen displaying at a third brightness, when the detected light brightness value of the screen within the visible range is more than or equal to the second light brightness threshold and less than the third light brightness threshold; and
adjusting the display brightness of the screen to make the screen displaying at a fourth brightness, when the detected light brightness value of the screen within the visible range is more than or equal to the third light brightness threshold.
